(19) United States
(12) Patent Application Publication
(10) Pub. No.: US 2014/0189793 A1
(43) Pub. Date: Jul. 3, 2014

(54) VIRTUAL FILE SYSTEM FOR INTERWORKING BETWEEN CONTENT SERVER AND INFORMATION-CENTRIC NETWORK SERVER AND OPERATING METHOD THEREOF

(71) Applicant: Electronics and Telecommunications Research Institute, Daejoen (KR)

(72) Inventors: Tae Yeon KIM, Daejeon (KR); Byung Joon LEE, Daejeon (KR); Hong Seok JEON, Daejeon (KR); Byeong Sik KIM, Daejeon (KR); Byong Kwon MOON, Daejeon (KR); Seung Hyun YOON, Daejeon (KR); Hyung Seok CHUNG, Daejeon (KR); In Sang CHOI, Daejeon (KR); Ho Young SONG, Daejeon (KR)

(73) Assignee: Electronics and Telecommunications Research Institute, Daejeon (KR)

(21) Appl. No.: 14/137,647

(22) Filed: Dec. 20, 2013

(30) Foreign Application Priority Data
Jan. 2, 2013 (KR) 10-2013-0000067

(51) Int. Cl. H04L 29/08; H04L 29/06

(52) U.S. Cl. CPC H04L 67/06; H04L 63/0853
USPC 726/3; 709/203

(57) ABSTRACT

Disclosed is a virtual file system for interworking between a content server and an information-centric network server, the system including: a file system function processing unit configured to process a file operation for a predetermined content requested from a plurality of content service protocols; a cache control unit configured to process the content requested through the file operation by managing a cache in a node; and a protocol matching unit configured to process the content requested through the file operation by interfacing with a plurality of content transfer protocols.

### CROSS-REFERENCE TO RELATED APPLICATIONS

This application claims priority to and the benefit of Korean Patent Application No. 10-2013-0000067 filed in the Korean Intellectual Property Office on Jan. 2, 2013, the entire contents of which are incorporated herein by reference.

### TECHNICAL FIELD

The present invention relates to a technology for interworking between a content server and an information-centric network server, and more particularly, to a virtual file system for interworking between a content server and an information-centric network server and an operating method thereof.

### BACKGROUND ART

In general, a content server, which provides a user with content services such as a streaming service, and the like, stores a content to be provided in a local storage, and provides the content in a manner of finding a content which the user desires and transferring the found content to the user. However, when considering the number of contents which is rapidly increased and a user's request for high definition and high quality, storing all contents, which are expected to be requested by the user, in the local storage causes a problem in extensibility, and there is a high possibility that service quality will be degraded due to a shortage in network bandwidth, and the like when a service request is concentrated on a specific server.

Although the content is stored in not the local storage but an external storage, the content request is still concentrated. As one scheme for solving the problem, a content-centric networking (CCN) technology for efficiently servicing the content through a network has been proposed. In the CCN technology, a hierarchical identifier is used, but the hierarchical identifier has no limit in a length thereof, and as a result, it is inappropriate to use transmission equipment for packet transmission.

As a scheme for solving the problem, an ID based information-centric networking (ICN) technology has been proposed, which uses a content ID which has no hierarchical information regarding the content, and efficiently finds and services content pieces chunked on the network based on the content ID. In this case, even though the content ID is extracted through a user's content service protocol that is requested to the content server, a protocol conversion work between the content service protocol and a content transfer protocol (that is, a content routing and a transfer protocol) is required to interwork with the content transfer protocol which is required in information-centric networking. However, since the user's content service protocol is serviced and evolved in various services and schemes, conversion for all protocols causes overhead.

A content network is not exclusively used by one service provider but needs to be shared and used by multiple service providers, in order to increase optimization and utility of a server, a storage, and a networking resource constituting the content network. In this case, each service provider needs to be able to use its own unique content transfer protocol.

### SUMMARY OF THE INVENTION

The present invention has been made in an effort to provide a virtual file system for interworking between a content server and an information-centric network server that can provide a content service regardless of a content service protocol and provide an interface, which is independent from a plurality of content transfer protocols, even when a content network is shared by a plurality of service providers, and an operating method thereof.

An exemplary embodiment of the present invention provides a virtual file system for interworking between a content server and an information-centric network server, the system including: a file system function processing unit configured to process a file operation for a predetermined content requested from a plurality of content service protocols; a cache control unit configured to process the content requested through the file operation by managing a cache in a node; and a protocol matching unit configured to process the content requested through the file operation by interfacing with a plurality of content transfer protocols.

The cache control unit may check whether the content is stored in the cache when a request for File_read of the content is received, and extract the content stored in the cache and transfer the extracted content to the file system function processing unit when the content is stored in the cache.

The protocol matching unit may find the content in an information-centric network and transfer the found content to the file system function processing unit when the content is not stored in the cache.

The system may further include an authentication processing unit configured to determine whether the requested content is effective and determine address information of a node at which the requested content is positioned when the requested content is effective.

The authentication processing unit may check whether the requested content corresponds to a content distributed to the information-centric network by referring to a registry that manages the position of the content, and read, from the registry, the address information of the node at which the requested content is positioned when the requested content is the distributed content.

Another exemplary embodiment of the present invention provides an operating method of a virtual file system for interworking between a content server and an information-centric network server, the method including: receiving an authentication request of a content file through a file operation OPEN(File) from the content server; inquiring of a registry whether a requested content is an effective content issued in an information-centric network by using a content transmission identifier (ID) extracted from the authentication request of the content file, and positional information of the content; and receiving the positional information of the content from the registry when the requested content is the effective content.

The method may further include storing the positional information of the content.

Yet another exemplary embodiment of the present invention provides an operating method of a virtual file system for interworking between a content server and an information-centric network server, the method including: receiving a request of a content file through a file operation READ(File) from the content server; checking whether a requested content file is present in a cache of the virtual file system; and transmitting a response including content file information to the content server when the requested content file is present in the cache.

The method may further include configuring a packet INTEREST for acquiring the requested content file information and transmitting the packet INTEREST to the information-centric network when the requested content file is not present in the cache.

The packet INTEREST may be configured by a chunk unit which is a data piece unit operated in the information-centric network.

The packet INTEREST may be configured by using address information of a node to which a requested content is distributed, and transmission identifier information and sub identifier information of the requested content.

The transmission identifier information and the sub identifier information may be extracted from the file operation READ(File) received from the content server.

The sub identifier information may include first sub identifier information regarding bitrate information representing the quality of the content and second sub identifier information which is an identifier of the chunk unit.

The second sub identifier information may be extracted in accordance with sub_id_{—}2=floor(x/M) to floor((x+sz)/M), and sub_id_{—}2 may represent the second sub identifier information, x may represent offset information of a content file, sz may represent the size of a content file to be read, and M may represent a chunk size of the information-centric network.

According to the exemplary embodiments of the present invention, various users' content service protocols may be used and a content network may be interworked through the same interface while being shared by multiple service providers. Accordingly, even when a new content service protocol or a new service provider shares the content network, separate protocol conversion is not required, thereby providing high extensibility.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a conceptual diagram of an information-centric network.

FIG. 2 illustrates one example of protocol interworking using a virtual file system according to an exemplary embodiment of the present invention.

FIG. 3 illustrates a configuration of the virtual file system according to the exemplary embodiment of the present invention.

FIG. 4 illustrates an operating method of a virtual file system in accordance with File_open according to an exemplary embodiment of the present invention.

FIG. 5 illustrates an operating method of a virtual file system in accordance with File_read according to an exemplary embodiment of the present invention.

FIG. 6 illustrates an embodiment of the present invention implemented in a computer system.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. In the following description and the accompanying drawings, like reference numerals designate substantially like elements, and the duplicated description will be omitted. In describing the present invention, well-known related functions or configurations will not be described in detail since the detailed description for the well-known related functions or configurations may unnecessarily obscure the understanding of the present invention.

The present invention proposes a virtual file system for interworking between a content server that provides a user with content services such as a streaming service, and the like and an information-centric network server for identifying a content on the information-centric network, finding the position of a content, and receiving the content, and an operating method thereof.

In the virtual file system according to the present invention, the content server and the information-centric network server interwork with each other through a file operation including an identifier of a content so as to maintain independence between a content service protocol and a content transfer protocol.

The present invention may be applied to a content service through the Internet, and particularly, to providing the content in an efficient and independent method in the information-centric network regardless of a type of a streaming protocol or a streaming server that provides a service such as a video on demand (VoD).

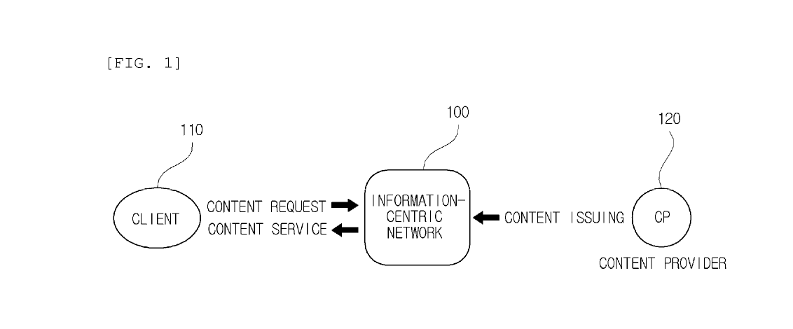

FIG. 1 is a conceptual diagram of an information-centric network.

An information-centric network is a collective name of a network of a type which finds a content requested by a user not a server outside the network but in the network, and transfers and services the found content to the user.

To this end, in an information-centric network 100, an interface with a user, that is, a client 110 is required. An interface with a content provider 120 having the content is required to issue the content into the network such that the content is distributed in the information-centric network 100.

In the information-centric network 100, the content issued by the content provider 120 is distributed and stored in a pattern optimized to a node constituting the network, and a function of finding a desired content at the time when the user requests a content service and providing a content service in an optimal node is performed.

The node constituting the information-centric network 100 may include not only network equipment such as a switch or a router, but also a server or a storage for providing the content.

In the node of the information-centric network 100 configured as above, a content server for providing the content service is operated in the direction of the user so as to provide the user with the content service such as video streaming, and an information-centric network server using the network equipment such as the switch or the router and the server or the storage is operated in the direction of the network so as to find the content distributed on the network and transfer the content through the network.

Accordingly, an interface is required between the content server and the information-centric network server which are present together within the node of the information-centric network 100. The content service includes various services such as a mass data service in addition to a representative video service, and various protocols are present for each service and each service needs to be provided to the user while interworking with an information-centric networking protocol, that is, a content transfer protocol. To this end, the present invention proposes an interworking scheme between the content server and the information-centric network server by using a virtual file system.

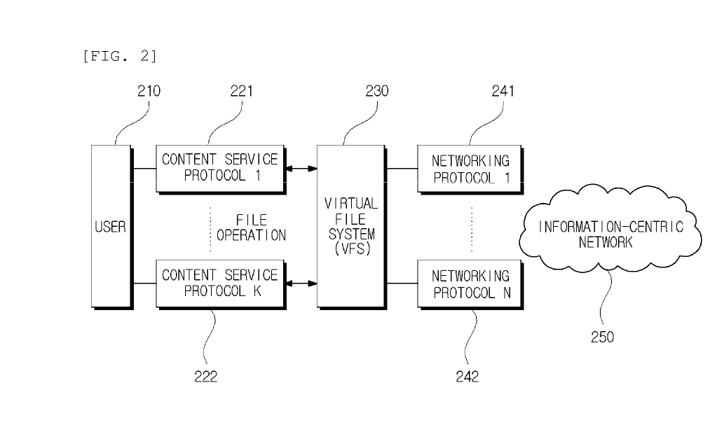

FIG. 2 illustrates one example of protocol interworking using a virtual file system according to an exemplary embodiment of the present invention.

Referring to FIG. 2, a user 210 may request a content service through various content service protocols 221 and 222. For example, a real-time streaming protocol (RTSP) for real-time streaming or a Http adaptive streaming (HAS) scheme using Http is primarily used and a protocol such as an FTP or a P2P protocol for just file transmission may be used. The content service protocol has variously evolved.

An information-centric network 250 needs to be able to be shared by various service providers rather than be exclusively used by one service provider or a network provider. This is to enhance service quality provided to the user by providing a service in an optimal scheme within the network in addition to efficiently using network resources. Therefore, the information-centric network 250 may be shared by various service providers, and the service providers may use their own unique content transfer protocols 241 and 242. For example, the service provides may use a P2P transfer protocol, or the Http or a typical TCP or UDP, and a CCN or other unique content transfer protocols.

As such, there is a problem in that complicated protocol conversion needs to be continuously performed without a consistent standard interface between various content service protocols and various content transfer protocols. Therefore, in the present invention, a file operation is used as illustrated in FIG. 2. That is, the content service protocol accesses a content file through the file operation, and as a result, the same interface is provided between different protocols. Herein, the file operation is the same as file processing operations of a user space, such as File_open, File_read, and the like.

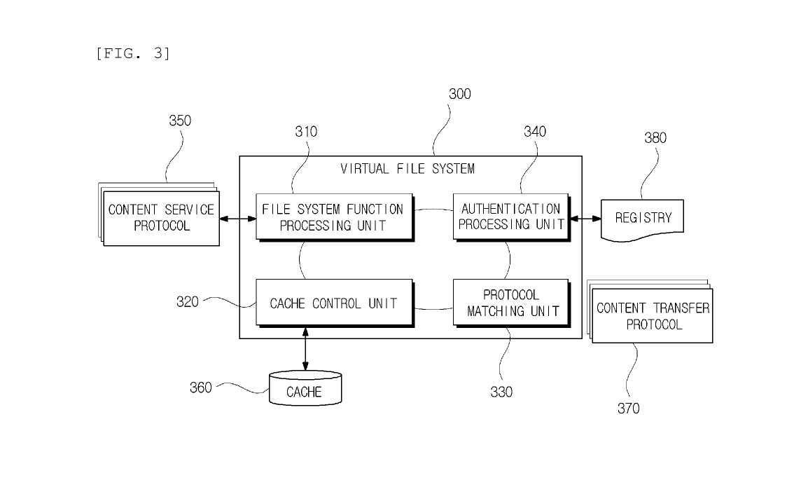

FIG. 3 illustrates a configuration of the virtual file system according to the exemplary embodiment of the present invention.

Referring to FIG. 3, a virtual file system 300 may be configured to include a file system function processing unit 310, a cache control unit 320, a protocol matching unit 330, and an authentication processing unit 340.

The file system function processing unit 310 processes a file operation for a requested file while interworking with various content service protocols 350. The file operation is mapped with a call-back function through the content service protocol 350, and a related call-back function is called and executed at the time when the file operation is executed.

The cache control unit 320 manages a cache 360 which is a storage stored in a node. In detail, when a processing request for a specific content is received through the file operation, the cache control unit 320 processes a corresponding content file through the management of the cache in the node. For example, when a request for File_read of the content is received, the cache control unit 320 preferentially checks whether a file requested by the content service protocol is stored in the cache 360. When the requested file is stored in the cache 360, the cache control unit 320 extracts the file stored in the cache 360 and transfers the extracted file to the file system function processing unit 310, thereby allowing the extracted file to be processed as a response to the file system function and used in the content service protocol 350.

On the contrary, when the file is not stored in the cache 360, a corresponding content needs to be found and received through another node distributed on the content network. Processing therefor is performed by the protocol matching unit 330.

When the protocol matching unit 330 is incapable of finding the file requested by the file system function processing unit 310 in the cache 360, the protocol matching unit 330 is in charge of interfacing with a content transfer protocol 370 so as to find the position of the corresponding content through the content transfer protocol 370 and achieve an optimal content transfer through a route for finding the corresponding content. FIG. 3 illustrates that the protocol matching unit 330 interfaces with the plurality of content transfer protocols 370. This expresses that when the content is transferred by a plurality of service providers through their unique protocols, one content network may interwork with the plurality of content transfer protocols 370 by the plurality of service providers, and the protocol matching unit 330 has a function of branching one content network depending on the plurality of content transfer protocols 370.

The authentication processing unit 340 checks whether the corresponding content is an effective content at the time when the file is opened, that is, the corresponding content corresponds to a content distributed to the information-centric network by referring to a registry 380, and reads address information of a node at which the corresponding content is positioned when the corresponding content is the distributed content. Herein, the registry 380 manages the position of the content, and means a storage storing a correlation between a corresponding node and a content identifier at the time when the content is issued on the information-centric network.

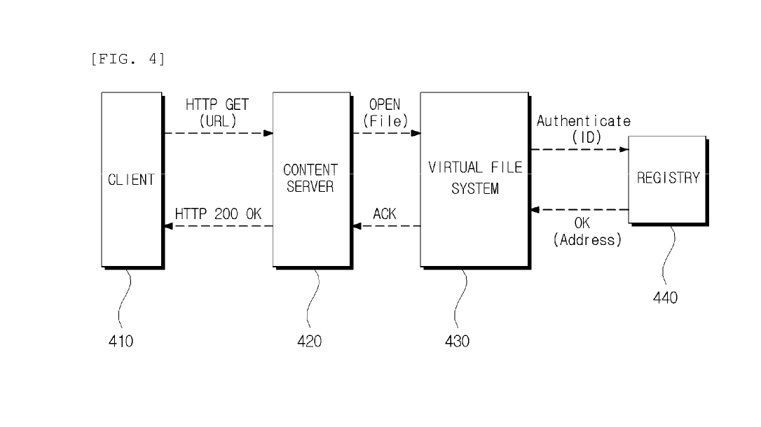

FIG. 4 illustrates an operating method of a virtual file system in accordance with File_open according to an exemplary embodiment of the present invention.

Referring to FIG. 4, when a user terminal, that is, a client 410 accesses a content server 420 through an HTTP protocol (HTTP GET(URL)), and the like, the content server 420 requests authentication of the file to a virtual file system 430 through a command of OPEN(File) which is the file operation. As a result, effectiveness of the content is checked together with the command of OPEN.

The virtual file system 430 extracts a content transmission identifier (ID) from the requested File (file?) and inquires of a registry 440 in order to acquire whether the corresponding content is the content issued in the network by using the extracted content transmission identifier (ID) and positional information of the corresponding content (Authenticate (ID)).

The registry 440 checks whether an identifier of the content is an effective identifier, that is, whether the corresponding content is the issued content. According to a checking result, when the corresponding content is the effective content normally issued and distributed in the information-centric network, the registry 440 returns positional information (for example, an IP address of a content service node) of the corresponding content (OK(Address)).

The virtual file system 430 stores the returned result and the positional information of the content, and thereafter, uses the stored result and positional information in the content transfer protocol.

Processing the command of Open of the file is performed through the aforementioned processes.

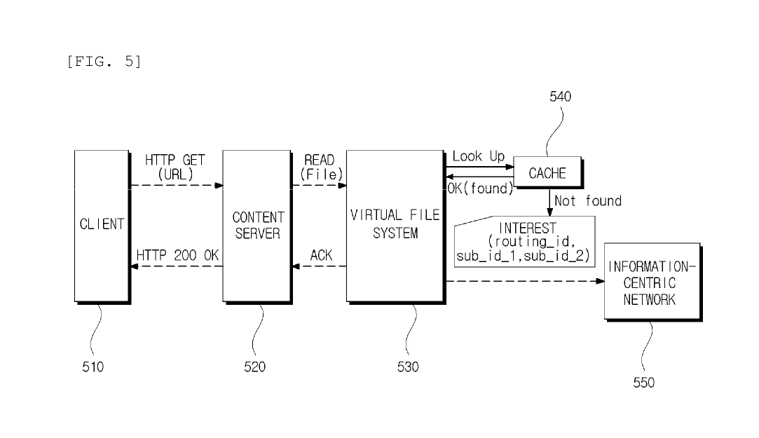

FIG. 5 illustrates an operating method of a virtual file system in accordance with File_read according to an exemplary embodiment of the present invention.

Referring to FIG. 5, as a user terminal, that is, a client 510 accesses a content server 520 through an HTTP protocol (HTTP GET(URL)), and the like, when the content server 520 makes a request to a virtual file system 530 through a command of READ(File) which is the file operation, the virtual file system 530 checks whether corresponding information is present in a cache 540 positioned in a node thereof (Look Up).

When the corresponding information is present in the cache 540, it is not necessary to bring data through an information-centric network 550, and as a result, the virtual file system 530 may transfer corresponding content information as a response to a command of Read.

On the contrary, when the cache 540 does not have the corresponding information, the virtual file system 530 configures a packet of INTEREST for acquiring the corresponding content information and thus transmits the packet INTEREST by an information-centric networking protocol and receives content data as a response thereto to find a corresponding file.

Herein, the packet INTEREST is operated by the unit of a data piece having a predetermined size by a protocol defined in the information-centric network 550, and the data piece unit is called a chunk. Therefore, the packet INTEREST of a series of chunk units needs to be generated in accordance with the command Read of the content server 520.

Information described below is required to configure the packet INTEREST of the chunk unit.

1. Address information of the node to which the content is distributed

2. Transmission identifier information of the content

Sub Identifier Information of the Content

Herein, the address information of the node to which the content is distributed may be acquired through a registry inquiry during the aforementioned file Open process. Hereinafter, a method of acquiring the identifier information of the content will be described.

When the content server 520 reads a file, a file name (File_Name), an offset, and a size are stated clearly. Herein, the File_Name indicates a specific content file, and includes information to enable uniqueness of the file to be verified. In other words, a unique content needs to be able to be identified by combining identifier information included in the File_Name. For example, when a specific file such as one FTP is distinguishable by one identifier, if only one identifier information is present in the File_Name, the file is identified in the information-centric network to access the content.

However, when the same content is encoded at bitrate of various qualities like Http adaptive streaming (HAS), the content is not distinguished through one transmission identifier, and when necessary, the content may be transmitted by changing the bitrate according to a request by a user terminal. In this case, while both transmission identifier information and bitrate information are designated in the File_Name, the file needs to be distinguished. In this case, a configuration method of the content identifier of the chuck unit required to configure the packet INTEREST will be described below.

1. The transmission identifier (routing_id) of the content is extracted from File_Name clearly stated in the function File_Read.

2. A sub identifier_{—}1 (sub_id_{—}1) of the content is extracted from File_Name clearly stated in the function File_Read. Herein, the sub identifier_{—}1 may be bitrate information corresponding to the quality of the content.

3. A sub identifier_{—}2 (sub_id_{—}2) of the content is extracted from File_Name clearly stated in the function File_Read. Herein, the sub identifier_{—}2 corresponds to the identifier of the chunk unit, and may be extracted by a method described below.

sub_id_{—}2=floor(x/M) to floor((x+sz)/M)

Herein, x represents offset information of the file, sz represents the size of a file to be read, and M represents a chunk size of the information-centric network.

Therefore, the identifier of the content transmitted to the protocol recorded in the packet INTEREST for acquiring the content information on the information-centric network is constituted by a combination described below.

[routing_id, sub_id_{—}1, sub_id_{—}2]

For example, when functions such as file_name=12345678_abcd_xxx_{—}350000_xxxxx, offset=5000, and sz=9000 are called through the file Read, 12345678 is used as the transmission identifier included in the file_name, 350000 corresponding to the bitrate is extracted as the sub identifier_{—}1, and when the chunk size is 1000, a series of content identifiers from [12345678, 350000, 5] to [12345678, 350000, 14] are extracted as the content identifier and transferred to the information-centric network server to collect information through the protocol.

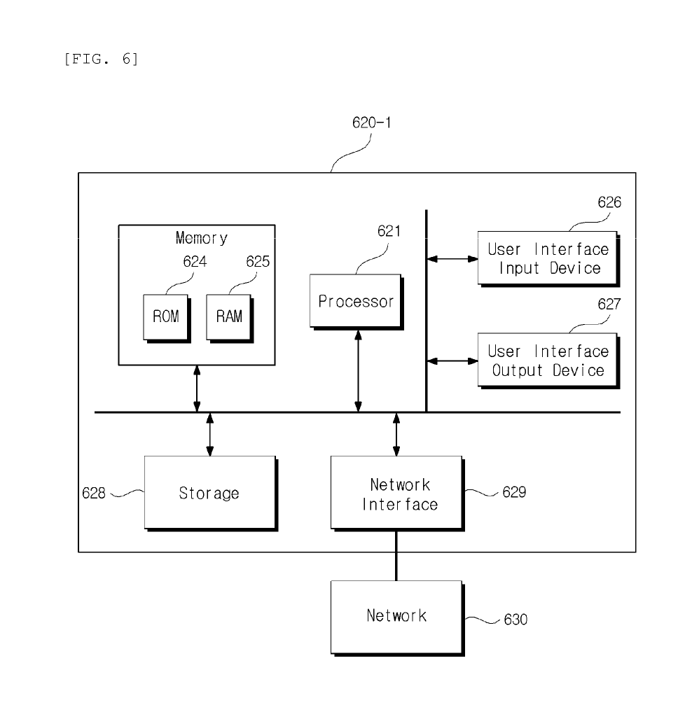

An embodiment of the present invention may be implemented in a computer system, e.g., as a computer readable medium. As shown in in FIG. 6, a computer system 620-1 may include one or more of a processor 621, a memory 623, a user input device 626, a user output device 627, and a storage 628, each of which communicates through a bus 622. The computer system 620-1 may also include a network interface 629 that is coupled to a network. The processor 621 may be a central processing unit (CPU) or a semiconductor device that executes processing instructions stored in the memory 623 and/or the storage 628. The memory 623 and the storage 628 may include various forms of volatile or non-volatile storage media. For example, the memory may include a read-only memory (ROM) 624 and a random access memory (RAM) 625.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A virtual file system for interworking between a content server and an information-centric network server, the system comprising:
a file system function processing unit configured to process a file operation for a predetermined content requested from a plurality of content service protocols;
a cache control unit configured to process the content requested through the file operation by managing a cache in a node; and
a protocol matching unit configured to process the content requested through the file operation by interfacing with a plurality of content transfer protocols.

2. The system of claim 1, wherein the cache control unit checks whether the content is stored in the cache when a request for File_read of the content is received, and extracts the content stored in the cache and transfers the extracted content to the file system function processing unit when the content is stored in the cache.

3. The system of claim 2, wherein the protocol matching unit finds the content in an information-centric network and transfers the found content to the file system function processing unit when the content is not stored in the cache.

4. The system of claim 1, further comprising:
an authentication processing unit configured to determine whether the requested content is effective and determine address information of a node at which the requested content is positioned when the requested content is effective.

5. The system of claim 4, wherein the authentication processing unit checks whether the requested content corresponds to a content distributed to the information-centric network by referring to a registry that manages the position of the content, and reads, from the registry, the address information of the node at which the requested content is positioned when the requested content is the distributed content.

6. An operating method of a virtual file system for interworking between a content server and an information-centric network server, the method comprising:
receiving an authentication request of a content file through a file operation OPEN(File) from the content server;
inquiring of a registry whether a requested content is an effective content issued in an information-centric network by using a content transmission identifier (ID) extracted from the authentication request of the content file, and positional information of the content; and
receiving the positional information of the content from the registry when the requested content is the effective content.

7. The method of claim 6, further comprising:
storing the positional information of the content.

8. An operating method of a virtual file system for interworking between a content server and an information-centric network server, the method comprising:
receiving a request of a content file through a file operation READ(File) from the content server;
checking whether a requested content file is present in a cache of the virtual file system; and
transmitting a response including content file information to the content server when the requested content file is present in the cache.

9. The method of claim 8, further comprising:
configuring a packet INTEREST for acquiring the requested content file information and transmitting the packet INTEREST to the information-centric network when the requested content file is not present in the cache.

10. The method of claim 9, wherein the packet INTEREST is configured by a chunk unit which is a data piece unit operated in the information-centric network.

11. The method of claim 9, wherein the packet INTEREST is configured by using address information of a node to which a requested content is distributed, and transmission identifier information and sub identifier information of the requested content.

12. The method of claim 11, wherein the transmission identifier information and the sub identifier information are extracted from the file operation READ(File) received from the content server.

13. The method of claim 11, wherein the sub identifier information includes first sub identifier information regarding bitrate information representing the quality of the content and second sub identifier information which is an identifier of the chunk unit.

14. The method of claim 13, wherein the second sub identifier information is extracted in accordance with sub_id_{—}2=floor(x/M) to floor((x+sz)/M), and sub_id_{—}2 represents the second sub identifier information, x represents offset information of a content file, sz represents the size of a content file to be read, and M represents a chunk size of the information-centric network.
